(19) United States
(12) Patent Application Publication
(10) Pub. No.: US 2005/0097214 A1
(43) Pub. Date: May 5, 2005

(54) Network peripheral device and installation method thereof

(76) Inventors: Shu-Yi Chen, Taipei City (TW); Chang-Hung Lee, Dounan Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/979,961

(22) Filed: Nov. 3, 2004

(30) Foreign Application Priority Data
Nov. 3, 2003 (TW) 92130604

(51) Int. Cl. G06F 13/12

(52) U.S. Cl. 709/231

(57) ABSTRACT

A network peripheral and installation method thereof for downloading built-in programs of the network peripheral device to the computer and having these downloaded programs installed therein. The network peripheral device has an built-in network unit and a built-in network server. The network unit is for creating network connection to the computer system. After the network connection is established, the network server is started. A browser in the computer system may be opened and connected to the network server by means of a recognition code of the network server. After being connected to the network server, the browser may display all relevant programs. If clicked by the user, a program will be automatically downloaded to and installed in the computer system.

This application claims the benefit of Taiwan application Serial No. 92130604, filed Nov. 3, 2003, the subject matter of which is incorporated herein by reference.

### BACKGROUND OF THE INVENTION

1. Field of the Invention

The invention relates in general to an installation method of a peripheral device, and more particularly to a disk-free installation method of a wireless network peripheral device.

2. Description of the Related Art

With the rapid advance in computer science and wireless network technology, multimedia devices installed at a household may be linked together, allowing the user to enjoy multimedia entertainment wirelessly by means of a wireless gateway. Under such configuration, the computer system really plays a critical role in management. The user may save the multimedia files of TV programs downloaded from the network to a computer hard disk and further use management software provided by the wireless gateway to arrange these files.

A wireless peripheral device of a network is generally sold with an optical disk containing the driver thereof and various application software for system installation, because wireless devices of the like are not the standard specifications that the computer system support. In other words, a disk installation routine providing the computer system with necessary programs is required for the installation and initialization of the wireless peripheral device of a network. Despite the fact that a disk installation routine does not cause much trouble, the disk installation routine needs an optical disk drive and creates the following shortcomings, which perplex the manufacturer and the consumer to a certain degree.

1. The manufacturer needs to pay extra costs in the manufacturing of optical disks containing driver programs and application software, so as to reduce potential profits.

2. All optical disks containing driver programs need to be kept at a safe place, causing a troublesome burden to the user.

3. When several computers are used, these computers need to go through the installation routine one computer by one computer, which is indeed very time consuming.

To resolve the above shortcomings, the conventional installation method needs to be examined and improved so as to make the installation routine simpler and easier.

### SUMMARY OF THE INVENTION

It is therefore an object of the invention to provide an installation method of a peripheral device to improve the efficiency and convenience of software installation.

According to the object of the invention, an installation method of a peripheral device including the steps disclosed below is provided.

Standardized network programs have already been widely used in computer system. A standardized network peripheral device and computer system generally support plug-and-play specification, and network function can be utilized conveniently when a connection is established between them. However, quite often, an additional installation disk is needed, because the computer system hardly provides any built-in drivers or application programs for other non-standardized peripheral devices such as a printer or a projector. A peripheral device with network function can then be easily installed by means of the installation method of the invention. The installation method of a network peripheral device installs the network peripheral device by downloading a built-in program of the network peripheral device to the computer system. The network peripheral device has a built-in network server. The network interface between the network peripheral device and the computer can be standardized, so the network peripheral device may be connected to the computer system immediately. After the network server is started after the connection is established, the network peripheral device sending out a recognition code to the computer system. The user may open a browser in the computer system and use the recognition code of the network peripheral device to connect the network server. After having been connected to the network server, the browser may display a list of the relevant programs in the network peripheral device. A program, when selected by the user, will be automatically downloaded via the network and installed in the computer system.

According to the object of the invention, an installation method of network peripheral devices including the steps disclosed below is provided.

The installation method of network peripheral devices may be applied in a wireless network system, allowing the computer to download the software of the network peripheral device via an access point and to have the downloaded software installed. The computer is connected to the access point by means of a wireless interface; the network peripheral device has a network server containing various programs. The network peripheral device obtains a recognition code from the access point after having been connected to the access point. If the user would like to download any software by a computer system, the user only needs to open a browser in the computer system and input the name of the network peripheral device, then the access point will convert the name of the network peripheral device into the recognition code. The access point redirects the browser's destination to the network peripheral device. After the browser having been connected to the network server, the browser may display a list of all relevant programs in the network server. If one of the programs selected by the user from the browser, a program will be automatically downloaded to and installed in the computer system.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a wireless system according to embodiment one of the invention.

FIG. 2 is a flowchart of an installation method of a peripheral device applied in the wireless system of FIG. 1.

FIG. 3 is a block diagram of a wireless system according to embodiment two of the invention.

FIG. 4 is a flowchart of an installation method of a peripheral device applied in the wireless system of FIG. 3.

### DETAILED DESCRIPTION OF THE INVENTION

Referring to FIG. 1, a block diagram of a wireless system according to embodiment one of the invention is shown. The structure includes a peripheral device 110 and a computer system 150, wherein the peripheral device 110 is equipped with a network unit 105 and a network server 107. A number of program files are stored in the network server 107, wherein these program files may be installation programs related to the peripheral device 110, such as driver programs and application programs, to be downloaded when their connection with the computer system 150 is established. The network unit 105 may be an interface complying with IEEE802 standard transmission specification, while the computer system 150 may be a personal computer equipped with a network card corresponding to the network unit 105. In most cases, the computer system 150 supports standard network protocols and may communicate directly with the network unit 105 as long as the computer system 150 and the network unit 105 are within the same network. The network server 107 has a main web-page including a plurality of links corresponding to the above installation programs. The user may click on the links of various installation programs on the main web-page to download programs when the computer system 150 opens a browser and is linked to the main web-page via the network unit 105. In practical application, the peripheral device 110 may be a wireless gateway or an electronic device with network functions. By means of the wireless technology, the computer system 150 may be linked to the network unit 105 directly and download required programs by means of the network server 107 for installing the network peripheral device 110 without using any optical disk or other storage medium.

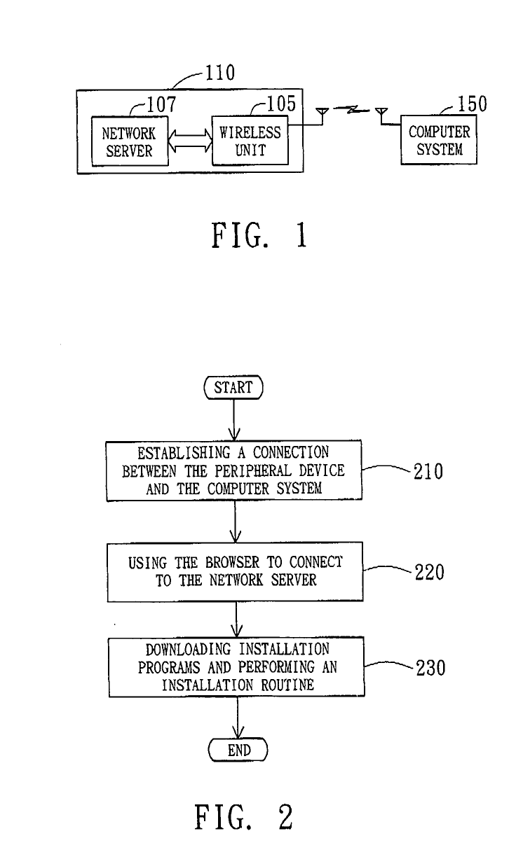

Referring to FIG. 2, a flowchart of an installation method of a peripheral device applied in the wireless system of FIG. 1 is shown. The peripheral device 110 may be connected to the computer system 150 by means of the network unit 105 after having been started so as to obtain a recognition code, a website address for instance; meanwhile, a network server 107 is also started (step 210). Next, the user can open a browser, Internet Explorer or Netscape for instance, in the computer system 150 so as to be linked to the network server 107 according to the recognition code to browse the contents of these installation programs (step 220). Meanwhile, the browser may display an HTML webpage of software downloading message including driver programs and application programs. The user only needs to click on required programs for these programs to be downloaded to the computer system 150 and installed therein (step 230). Under such structure, several computers may be linked to the network server 107 to download and install required software, greatly shortening installation time and largely increasing efficiency. For example, when the network peripheral device is a wireless printer, which may be used by several users at the same time, each computer need to be installed with the driver program or application program by means of disk installation according to a conventional installation method. In one embodiment of the invention, all computers may be linked to the HTML webpage including software downloading information of the wireless printer to process installation. In practical application, the network peripheral device 110 may be linked to the wireless gateway or the access point first, via which the computer system 150 is connected to the network peripheral device 110 to download the installation programs. When the network peripheral device 110 is connected to the wireless gateway, the wireless gateway will record the recognition code of the network peripheral device 110, so that the computer system 150 will use the name of the network peripheral device 110 to inquire the wireless gateway about the recognition code of the network peripheral device 110 to establish connection. This way of embodiment is elaborated further in the next embodiment.

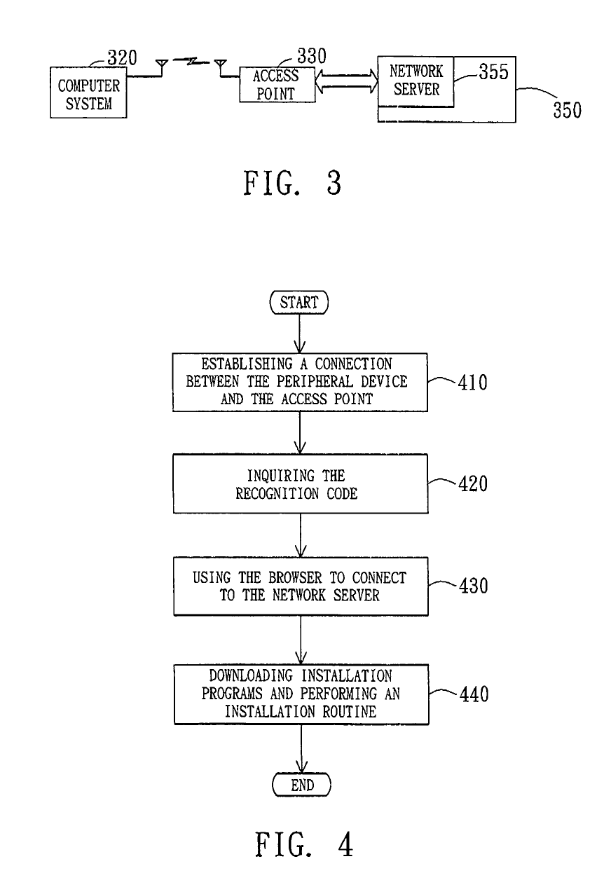

Referring to FIG. 3, a block diagram of a wireless system according to embodiment two of the invention. This structure includes a computer system 320, an access point 330 and a network peripheral device 350. The network peripheral device 350, such as a network printer or a network scanner for instance, also has built-in installation programs such as a driver program or various application software, which may be downloaded by a network server 355. After the network peripheral device 350 is coupled to the access point 330 regardless of using a wire or wireless, the computer system 320 may be connected to the network device 350 by means of the access point 330 to select and download the needed software. When the working environment is an office or a computer classroom when several personal computers are needed, such structure makes full use of the convenience of disk-free installation.

Referring to FIG. 4, a flowchart of an installation method of a peripheral device applied in the wireless system of FIG. 3 is shown. When the network peripheral device 350 is connected to the access point 330, the network server 355 is started together with the network peripheral device 350; meanwhile, the access point 330 records the name of the network peripheral device 350 and gives a recognition code to the network peripheral device 350 (step 410). Next, the computer system 320 uses the name of the network peripheral device 350 to inquire the recognition code of the network peripheral device 350 given by the access point 330 so as to recognize the identity of the network peripheral device 350 (step 420). If the user would like to download software, the user may open the browser in the computer system 320 and establish connection with the network server 355 by means of the recognition code to browse the content of installation programs (step 430). Meanwhile, the browser may display an HTML webpage of software downloading message including driver programs and application programs. The user only needs to click on required programs for these programs to be downloaded to the computer system 320 and installed therein (step 440).

The installation method of a network peripheral device disclosed in the above embodiments has the following advantages:
1. The manufacturer does not need to pay extra costs in the manufacturing of optical disks containing driver programs and application software, so that the potential profit is increased.
2. The storage problem of the installation disk is resolved.
3. When several personal computers are used, these computers may perform the installation routine at the same time to save operation time.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An installation method for a peripheral device, the peripheral device having a network unit and a network server, the network server containing a plurality of installation programs, the installation method comprising the steps of:
starting the peripheral device, the peripheral device making a connection to the computer system via the network unit and sending a recognition code to the computer system;
starting the network server;
opening a browser in the computer system and establishing a connection with the network server according to the recognition code; and
using the browser for selectively downloading the installation programs to the computer system.

2. The installation method of a peripheral device according to claim 1, wherein the network server has a main web-page having a plurality of links corresponding to the installation programs, and the browser is connected to the main web-page.

3. The installation method of a peripheral device according to claim 1, wherein the recognition code is a website address.

4. The installation method of a peripheral device according to claim 1, wherein the installation programs comprise driver programs or application programs of the peripheral device.

5. The installation method of a peripheral device according to claim 1, wherein the network unit is a wireless communication interface complying with IEEE 802.11 transmission specification.

6. The installation method of a peripheral device according to claim 1, wherein the peripheral device is a wireless gateway.

7. The installation method of a peripheral device according to claim 5, wherein the computer system is connected to a wireless gateway via which the computer system is connected to the peripheral device.

8. The installation method of a peripheral device according to claim 7, wherein the wireless gateway records the recognition code when connected to the peripheral device.

9. The installation method of a peripheral device according to claim 8, wherein the computer system uses a name of the peripheral device to inquire the wireless gateway about the recognition code of the peripheral device.

10. The installation method of a peripheral device according to claim 1, wherein the installation routine of the selected installation program is executed.

11. An installation method of a peripheral device having a built-in network server and a plurality of installation programs, wherein the peripheral device communicates with a computer system by means of an access point (AP), the installation method comprising the steps of:
establishing connection between the peripheral device and the access point to obtain a recognition code and start the network server;
inquiring the access point about the recognition code of the peripheral device by the computer system;
opening a browser in the computer system and establishing connection to the network server according to the recognition code; and
using the browser to selectively download the installation programs to the computer system.

12. The installation method of a peripheral device according to claim 11, wherein the network server has a main web-page having a plurality links corresponding to the installation programs, and the browser is connected to the main web-page.

13. The installation method of a peripheral device according to claim 11, wherein the recognition code is a website address.

14. The installation method of a peripheral device according to claim 11, wherein the installation programs comprise driver programs or application programs of the peripheral device.

15. The installation method of a peripheral device according to claim 10, further comprising:
the access point recording a name of peripheral device when connected to the peripheral device.

16. The installation method of a peripheral device according to claim 15, wherein the computer system sends the name of the peripheral device to inquire the access point about the recognition code.

17. The installation method of a peripheral device according to claim 11, wherein the installation routine of the selected installation program is executed.

18. A peripheral device, the peripheral device being a peripheral of a computer having a browser installed within, the peripheral device comprising:
a network unit;
a network server comprising a plurality of programs of the peripheral device;
wherein when the peripheral device is started, the network unit connecting to the computer and obtaining a recognition code, the recognition code for the browser to connect the network server via the network unit for selectively downloading the programs of the peripheral device.

19. The peripheral device according to claim 18, wherein the network server has a main web-page having a plurality of links corresponding to the programs, the browser opening the main web-page when the browser connected to the network server.

20. The peripheral device according to claim 18, wherein the network unit is a wireless communication interface.

21. The peripheral device according to claim 18, wherein the recognition code is a website address.
